(19) United States
(12) Patent Application Publication
(10) Pub. No.: US 2004/0007606 A1
(43) Pub. Date: Jan. 15, 2004

(54) Slidable cutter for cutting sheet material

(76) Inventor: Forest E. Baker JR., Lansdale, PA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/446,630

(22) Filed: May 28, 2003

Related U.S. Application Data
(60) Provisional application No. 60/383,730, filed on May 28, 2002.

(51) Int. Cl. B26F 3/00

(52) U.S. Cl. 225/1; 225/56; 225/91

(57) ABSTRACT

A cutter for cutting sheet materials such as plastic film or metal foil is provided. The cutter incorporates a handle, a cutting blade and a hook for attaching the cutter to a dispenser of the sheet material. The cutter rides along the top of the box to cut the sheet material.

### PRIORITY CLAIM

This application claims priority Under §119 to U.S. Provisional Application No. 60/383,730, filed on May 28, 2003, which is hereby incorporated herein by reference.

### FIELD OF THE INVENTION

The present invention relates to cutters for cutting sheet materials. More specifically, the present invention relates to sliding cutters used to cut plastic film or metallic foils that are dispensed from a roll.

### BACKGROUND OF THE INVENTION

Plastic film and metal foil are widely used throughout the food industry to wrap or cover various food products. The film or foil is typically dispensed from a roll contained in a box. Whenever a piece of film or foil is required, the length of the film or foil is withdrawn from the box and cut to length by a cutter that is attached to the carton or to a cardboard insert placed in the front of the carton. One such cutter is a sliding cutter that slides in a track. The known sliding cutters are complicated devices having a separate track that is attached to the top surface of the box and a cutter that is configured to ride in the track. Since these cutters are complicated structures they are expensive to manufacture. Accordingly, there is a need for a simplified low cost sliding cutter.

### SUMMARY OF THE INVENTION

In accordance with the present invention, an inexpensive sliding cutter for cutting sheet materials is provided. The cutter eliminates the need for a separate track, which significantly reduces the cost of the cutter.

The cutter allows a user to withdraw a length of sheet material, such as plastic film or metal foil from a dispenser, and cut the film or foil to length without serious risk of injury to the user. The cutter has a handle with an attached cutting blade and a hook for attaching the cutter to the dispenser. The cutter is attached to the box so that it is disposed within the box in a gap formed between the front wall of the box and a flap tucked into the box. The cutter handle rides on top of the box straddling the gap between the front wall and the box flap. In this way, the cutter is operable to slide along the length of the box to cut the sheet material to length.

### BRIEF DESCRIPTION OF THE DRAWINGS

All of the objectives of the present invention are more fully set forth hereinafter with reference to the accompanying drawings in which like numbers represent like features, wherein:

FIG. 1 is a side view of a box containing a roll of sheet material and a slidable cutter;

FIG. 2 is a fragmentary front view of the box containing a roll of sheet material and slidable cutter illustrated in FIG. 1;

FIG. 3 is a fragmentary perspective view of the box containing a roll of sheet material and slidable cutter illustrated in FIG. 1;

FIG. 4 is a front elevational view of the cutter illustrated in FIG. 3;

FIG. 5 is a side view of the cutter illustrated in FIG. 4;

FIG. 6 is a front elevational view of a second cutter;

FIG. 7 is a side view of the cutter illustrated in FIG. 6;

FIG. 8 is a front elevational view of a third cutter;

FIG. 9 is a side view of the cutter illustrated in FIG. 8; and

FIG. 10 is a bottom view of the cutter illustrated in FIG. 8.

### DETAILED DESCRIPTION OF THE PREFERRED EMBODIMENTS

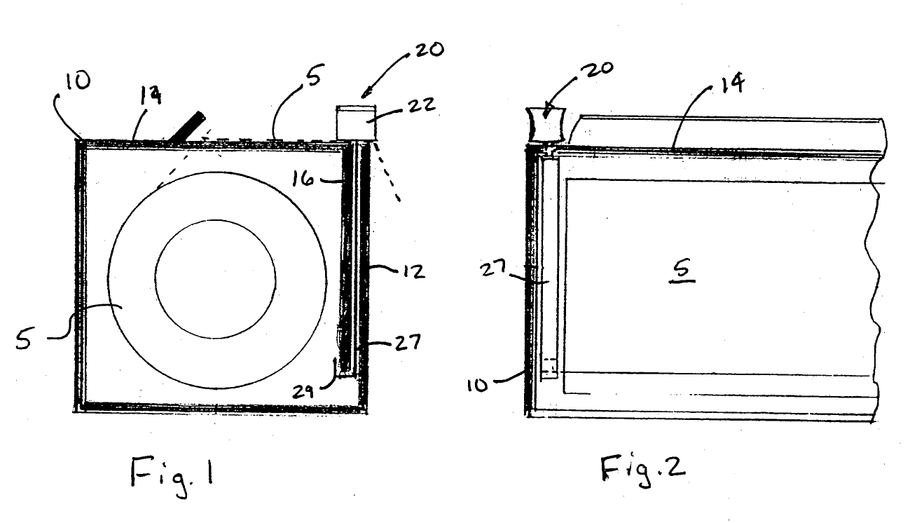

Referring now to the drawings in general and to FIGS. 1-5, a roll of sheet material 5, such as plastic film or aluminum foil, is contained within a box 10. A cutter 20 disposed in the box is operable to cut off a piece of the sheet material. More specifically, a desired length of sheet material may be pulled out of the box 10 off of the roll 5 and cut off by the cutter 20. The cutter 20 slides along the length of the box 10 to cut off the sheet material.

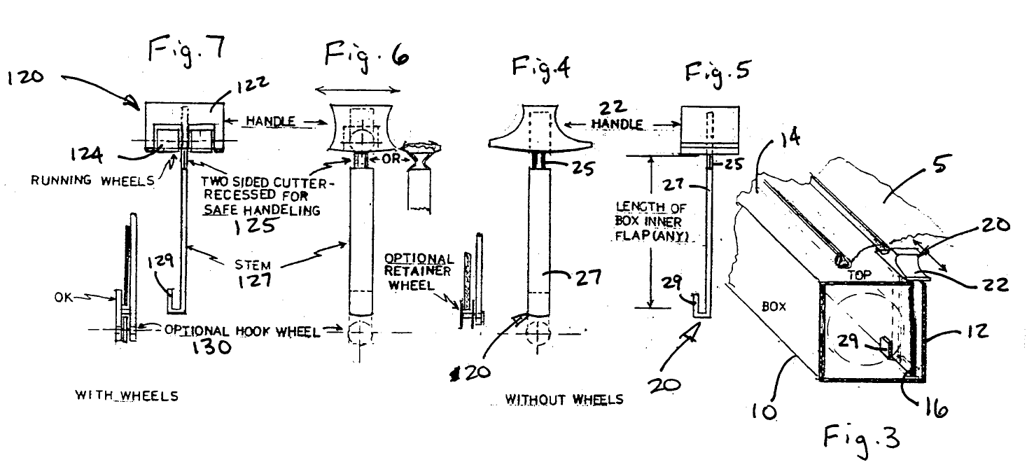

The box 10 has a front wall 12 and a top 14. A flap 16 attached to the top 14 is tucked into the box adjacent the front wall 12. A gap or slot is formed between the flap 16 and the front wall 12. The cutter 20 is disposed within this slot as discussed further below. An opening is formed in the top 14 of the box so that the sheet material 5 can be pulled off the roll through the opening in the top of the box, as shown in FIGS. 1 and 3. The length of the box 10 is longer than the length of the roll 5 so that the roll can be contained within the box. In addition, preferably the top 14 and flap 16 are substantially coextensive with the front wall 12 of the box.

Referring to FIGS. 4 and 5, the cutter 20 comprises a handle 22 that is wider than the width of the slot between the flap 16 and the front wall 12. A blade 25 is fixedly attached to handle 22. The blade 25 has two cutting edges, a right edge and a left edge so that the cutter 20 can cut the sheet material 5 regardless of whether the cutter is slid from right to left or left to right, as discussed further below. A vertically elongated stem 27 is attached to the bottom edge of the blade. The stem 27 has a thickness that corresponds to the width of the slot between the front wall 12 and the flap 16 of the box. More specifically, preferably the stem 27 has a thickness that is the same as or less than the width of the slot so that the cutter 20 can slide readily within the slot. The lower edge of the stem 27 forms a reverse curve forming a hook 29 as shown in FIG. 5.

Referring to FIGS. 1-3, the cutter 20 is disposed within the box 10 so that the stem 27 and blade 25 are disposed within the slot between the front wall 12 and the flap 16 of the box. The front edge of the box top 14 and the top edge of the front wall 12 provide bearing surfaces upon which the bottom of the cutter handle 22 rides. Since the handle 22 is wider than the slot between the flap 16 and the front wall 12, the handle 22 spans the slot, and rides along the front edge of the box top 14 and the top edge of the front wall 12. The hook 29 at the bottom of the stem 27 hooks around the bottom of the flap 16 to prevent the box top 14 and flap 16 from being displaced downwardly relative to the top edge of the front wall 12 of the box, which would otherwise misalign the bearing surfaces upon which the cutter handle 22 rides.

To cut off a piece of sheet material 5, the operator pulls the sheet material off the roll through the opening in the top 14 of the box 10. The sheet material is pulled over the front edge of the box so that it rests on the front edge of the flap 16 and the top edge of the front wall 12. To cut the sheet material, the cutter 20 is slid along the length of the box. As the cutter 20 is slid, the bottom surface of the handle 22 rides over the sheet material so that the sheet material is held down between the handle and the box 10. For this reason, preferably the bottom surface of the handle is a low friction surface. This can be accomplished by either forming the entire handle out of a low friction material or by coating the bottom surface of the handle with a low friction material.

As the cutter 20 is slid along the length of the box, the blade 25 cuts the sheet material 5. When the cutter 20 is slid from right to left, the left edge of the blade 25 cuts the material. When the cutter is slid from left to right, the right edge of the blade cuts the material. As the cutter is slid along the length of the box, preferably the hook 29 at the bottom of the stem 27 remains engaged with the bottom edge of the flap 16.

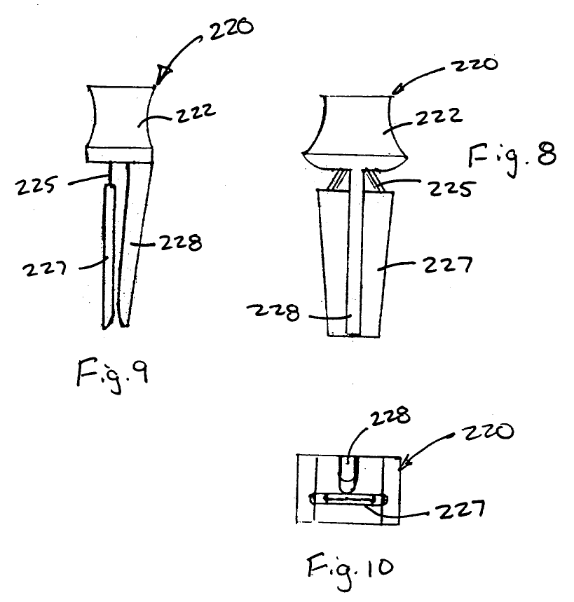

Referring now to FIGS. 6 and 7, a second cutter is designated 120. The second cutter 120 is configured similarly to the cutter 20 illustrated in FIGS. 4 and 5, with the addition of wheels that provide a smoother interface between the cutter and the box 10. Specifically, the second cutter comprises a handle 122 to which a blade 125 is fixedly attached. The stem 127 is attached to the bottom edge of the blade and the lower edge of the stem forms a hook 129.

Referring to FIG. 7, a plurality of handle wheels 124 are rotatably mounted to the handle. Preferably the wheels 124 in the handle are appropriately sized and located so that the wheels ride over the front edge of the box top and the top edge of the front wall 12, straddling the slot between the flap 16 and the front wall 12. In addition, a hook wheel 130 is rotatably attached to the hook 129. The hook wheel 130 is disposed so that it is operable to ride along the bottom edge of the box flap 16. The handle wheels 125 and hook wheel 129 provide a smooth rolling interface between the cutter 120, the sheet material 5 and the box 10 so that the cutter can readily slide along the box to cut the sheet material. Although the second cutter in 120 has been described with both the handle wheels 124 and the hook wheel 130, in certain situations it may be desirable to incorporate only one of the two types of wheels.

Referring now to FIGS. 9-10, a third cutter is designated 220. The third cutter 220 comprises a handle 222, a blade 225 attached to the handle, and a vertically elongated stem 227 fixedly attached to the bottom edge of the blade. The stem 227 has a thickness that corresponds to the width of the slot between the front wall 12 and the flap 16 of the box. More specifically, preferably the stem 227 has a thickness that is the same as or less than the width of the slot so that the cutter 220 can slide readily within the slot.

The third cutter 220 also includes a hook for engaging the box 10. However on the third cutter the hook is in the form of a clip 228 attached to the bottom edge of the handle, rather than the bottom edge of the stem 227. More specifically, the clip 228 comprises a vertically elongated radially deformable finger. The clip 228 is spaced apart from the stem 227 to form a gap between the clip 228 and the stem 227. The cutter 220 is disposed in the box so that the stem 227 rides in the slot between the flap 16 and the front wall 12 of the box, and the clip 228 hooks over the front wall 12 of the box so that the front wall is disposed in the gap between the stem 227 and the clip 228. Preferably, the gap between the stem and clip is at least slightly smaller than the thickness of the front wall 12 of the box so that the clip 228 deforms outwardly away from the stem 227 when the cutter is hooked on the box.

As shown in FIG. 8, preferably the blade 225 is a double-edged blade having a right edge and a left edge. Preferably the sides of the blade are tapered downwardly so that the blade is wider at the top then at the bottom. In this way, the intersection between the right and left edges of the blade and the bottom surface of the handle form obtuse angles.

While particular embodiments of the invention have been herein illustrated and described, it is not intended to limit the invention to such disclosures, but changes and modifications may be made therein and thereto within the scope of the following claims. For instance, the cutters 20 and 120 have been described as having a stem that has a fixed length. However, in certain applications it may be desirable to utilize an adjustable length stem so that the hook 29, 129 can hook over boxes having various height flaps 16. Such an adjustable may comprises a two-piece stem having a biasing element, such as a spring, biasing the stem to a short position.

1. A cutter for cutting sheet material on a roll in a box, wherein the box comprises a top surface, a front flap attached to the top surface, and a front wall wherein a slot having a width is formed between the front flap and the front wall, wherein the cutter comprises:
a handle having a width that is greater than the width of the slot between the front flap and the front wall of the box;
a cutting blade attached to the handle; and
a hook for hooking the cutter onto the box, so that the cutter is operable to ride over the top surface and the front wall of the box to cut the sheet material.

2. A cutter for cutting sheet material on a roll in a box, wherein the box comprises a top surface, a front flap attached to the top surface, and a front wall wherein a slot having a width is formed between the front flap and the front wall, wherein the cutter comprises:
a handle having a width that is greater than the width of the slot between the front flap and the front wall of the box;
a cutting blade attached to the handle; and
a guide connected with handle and operable to guide the handle to maintain the handle in a position in which the handle straddles the slot between the front flap and the front wall of the box while the cutter slides along the length of the box.

3. The cutter of claim 2 wherein the guide is configured to cooperate with the slot.

4. A method for cutting sheet material, comprising the steps of:
providing a box containing a roll sheet material, wherein the box comprises a top surface, a front flap attached to the top surface, and a front wall wherein a slot having a width is formed between the front flap and the front wall;
providing a cutter for the sheet material;
pulling a length of sheet material off of the roll so that the sheet material overlies the front edge of the box; and
sliding the cutter within the slot to cut the sheet material.

5. The method of claim 4 wherein the cutter comprises a handle having a width that is wider than the width of the slot, and the step of sliding comprises sliding the handle over the slot so that the handle is supported by the box top and the front wall of the box.
